(19) United States
(12) Patent Application Publication
(10) Pub. No.: US 2013/0003693 A1
(43) Pub. Date: Jan. 3, 2013

(54) METHOD FOR OPERATING A CELLULAR RADIO SYSTEM AND A CELLULAR RADIO SYSTEM

(75) Inventors: Michael Einhaus, Heidelberg (DE); Andreas Maeder, Heidelberg (DE)

(73) Assignee: NEC EUROPE LTD., Heidelberg (DE)

(21) Appl. No.: 13/512,221

(22) PCT Filed: Nov. 25, 2009
(86) PCT No.: PCT/EP2009/008400

§ 371 Date: Aug. 15, 2012

(51) Int. Cl. H04W 72/08

(52) U.S. Cl. 370/330; 370/329

(57) ABSTRACT

For allowing a very high performance level without adding significant complexity to known methods a method for operating a cellular radio system within which at least two different Fractional Frequency Reuse (FFR) zones are defined in a downlink frame, the method including the following steps: providing a metric for assigning a respective preference criterion to each of at least some flows to be served within the radio system, wherein the metric is related to the relative resource quality in the zones for the at least some flows and to the relative zone size; assigning the respective preference criterion to each of the at least some flows; and assigning the at least some flows to the zones according to the respective preference criterion. Further, a corresponding cellular radio system, preferably for carrying out the above mentioned method, is described.

The present invention relates to a method for operating a cellular radio system within which at least two different Fractional Frequency Reuse (FFR) zones are defined in a downlink frame. Further, the present invention relates to a cellular radio system within which at least two different Fractional Frequency Reuse (FFR) zones are defined in a downlink frame.

In cellular radio systems like Mobile WiMAX (Worldwide Interoperability for Microwave Access), inter-cell interference is the predominant coverage-limiting factor. To avoid coverage holes at cell and sector edges, resource, i.e. frequency, allocation schemes are used which allocate orthogonal resource subsets, i.e. carrier subsets in case of OFDMA (Orthogonal Frequency Division Multiple Access) based Mobile WiMAX, for adjacent cells/sectors, such that no interference between direct neighbors exists. However, since only a fraction of the available spectrum—subcarrier subsets—is used in each cell/sector, this can lead to a capacity reduction especially for mobile stations (MS) which have a high Signal-to-Interference-and-Noise-Ratio (SINR).

The concept of Fractional Frequency Reuse (FFR) combines the advantage of using frequency reuse factor 1, i.e. all devices transmit on the full set of available subcarriers, and lower frequency reuse factors, typically ⅓ in cellular deployments. This is accomplished by allowing full use of all subcarriers and a lower frequency reuse factor in a quasi-parallel manner by applying time domain separation in the radio frame. This allows for high data rates for users close to the base station (BS), and good coverage for users at cell and sector edges.

In OFDMA based Mobile WiMAX systems, FFR is realized by time zones in each frame. One part of the frame is reserved for frequency reuse factor 1—Reuse 1 Zone—, and another one is reserved for lower frequency reuse factors, typically ⅓ in conventional cellular deployments—Reuse 3 Zone. The switching point between both zones can be adapted each radio frame. Each mobile station (MS) is either served in the Reuse 3 or Reuse 1 Zone of the downlink (DL) radio frame, depending on MS position and channel conditions, which are influencing signal quality.

For operation it has to be decided which flow or mobile station is served in which zone in order to maximize system capacity, coverage, Quality of Service (QoS), or any other performance metric. An according assignment procedure can depend on several variables. Thus, the problem as such is very complex.

In WiMAX Forum Whitepaper, “Mobile WiMAX—Part I: A Technical Overview and Performance Evaluation”, August 2006, is provided an overview of Mobile WiMAX. According to a development of the present applicant two methods for assigning flows to different reuse zones in FFR have been proposed, which are denoted as Max R1 and Max R3 with regard to different zones with frequency reuse factor 1 and 3, respectively. With Max R1, the Reuse 1 Zone is first filled up with service flows having the highest SINR levels in that zone; and with Max R3, the Reuse 3 Zone is filled up first.

Further, from FUJITSU Sci. Tech. J., 44, 3, p. 318-324 (July 2008) is obtainable a simulation study of fractional frequency reuse in WiMAX networks. Also from IEEE, 2008, 978-1-4244-1645-5/08/$25.00, Dr. Yuefeng Zhou, a simulation study of fractional frequency reuse for mobile WiMAX is known.

It is an object of the present invention to improve and further develop a method for operating a cellular radio system and an according cellular radio system for allowing a close to optimum performance without adding significant complexity to known methods and systems.

In accordance with the invention, the aforementioned object is accomplished by a method comprising the features of claim 1 and a system comprising the features of claim 15. According to claim 1 the method is comprising the following steps: Providing of a metric for assigning a respective preference criterion to each of at least some flows to be served within the radio system, wherein the metric is related to the relative resource quality in the zones for the at least some flows and to the relative zone size; assigning of the respective preference criterion to each of the at least some flows; and assigning of the at least some flows to the zones according to the respective preference criterion.

According to claim 15 the system is comprising means for processing of a metric for assigning a respective preference criterion to each of at least some flows to be served within the radio system, wherein the metric is related to the relative resource quality in the zones for the at least some flows and to the relative zone size; means for assigning of the respective preference criterion to each of the at least some flows; and means for assigning of the at least some flows to the zones according to the respective preference criterion.

According to the invention it has been recognized that it is possible to allow a high performance of a cellular radio system by providing a suitable metric for assigning a respective preference criterion to each of at least some flows to be served within the radio system, wherein the metric is taken into account the relative resource quality in the zones for the at least some flows and the relative zone size. Such a metric allows the assignment of the respective preference criterion to each of the at least some flows and the assignment of the at least some flows to the zones according to the respective preference criterion.

The inventive method is providing an increased robustness compared to existing methods in terms of variability in switching point position between the different reuse zones and number of flows to be served.

The inventive method and system are providing a close to optimum performance without adding significant complexity to known methods and systems.

Preferably, the method is further comprising the step of creating of a sorted list of the at least some flows according of the respective preference criterion after the step of assigning of the preference criterion to each of the at least some flows, so that the assigning of the at least some flows to the zones will be performed according to the list. Such a list is providing a very simple tool for operation of the system.

Within a preferred embodiment of the invention the list could be created in descending order with regard to the preference criterion. Thus, the assigning of the at least some flows to the zones could start with the first flow in the sorted list according to the preferred zone. If no resources are available anymore in the preferred zone, the flow is assigned to the other or to another zone.

With regard to a very effective method the relative resource quality could be related to the SINR (Signal-to-Interference-and-Noise-Ratio) with regard to the respective flow. Thus, the assignment of the at least some flows to the zones could be performed under consideration of the SINR of each flow with regard to the available zones.

The other parameter to which the metric is related is the relative zone size. Within a preferred embodiment of the invention the relative zone size could be related to the number of usable resources within the zones. Preferably, the usable resources are time-frequency slots in the radio system. Further, the Fractional Frequency Reuse (FFR) zones could be time zones.

With regard to very high effectiveness the assignment of the at least some flows to the zones according to the respective preference criterion could be performed by a base station (BS) of the radio system. Preferably, all input variables for the metric could be available at such a base station.

With regard to a simple performing of the inventive method the variables could be gathered by using a mobile station (MS) feedback mechanism, preferably downlink preamble SINR reports. Alternatively, the variables could be available as a system parameter.

Within a further preferred embodiment the amount of required resources for a flow in a given zone could be determined by the modulation and coding scheme (MCS) based on the SINR level and the throughput requirement.

The present invention is useful especially within a Mobile WiMAX system. Thus, the discussed radio system could be a Mobile WiMAX system.

Within a preferred cellular radio system all means for processing of a metric, for assigning of the respective preference criterion and for assigning of the at least some flows to the zones could be part of or could be integrated within a base station (BS) of the system for providing a very compact system.

The present invention constitutes a method to decide which flows or service flows and mobile stations, respectively, are served in which FFR zone in each frame, e.g. a Mobile WiMAX DL MAC frame. The method is considering the relative resource quality in the zones compared to all other flows or service flows and the relative zone size.

The zone assignment method could consist of three steps:

1. Step: Determination of a zone preference metric for at least some flows or service flows.
2. Step: Creation of a sorted list of the flows that have to be served in the current downlink radio frame, with the zone preference metric in descending order.
3. Step: Assignment of flows to zones, starting with the first flow in the sorted list according to the preferred zone.

The present invention is providing a metric for determining FFR zone preference of flows. The method shows an increased robustness compared to existing methods in terms of variability in switching point position and number of flows or service flows. Thus, the method shows a very good performance, even if the switching point between the reuse zones is varied. Further, the present invention is providing a flexible method for assigning service flows dynamically to fractional frequency reuse time zones in a radio frame for Mobile WiMAX systems.

There are several ways how to design and further develop the teaching of the present invention in an advantageous way. To this end, it is to be referred to the patent claims subordinate to patent claims 1 and 15 on the one hand, and to the following explanation of preferred examples of embodiments of the invention illustrated by the drawing on the other hand. In connection with the explanation of the preferred examples of embodiments of the invention by the aid of the drawing, generally preferred embodiments and further developments of the teaching will be explained. In the drawings

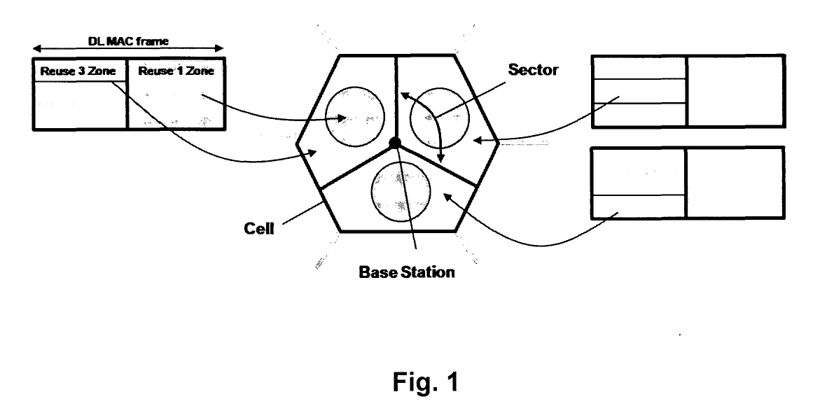

FIG. 1 is illustrating schematically fractional frequency reuse (FFR) as implemented by Mobile WiMAX and

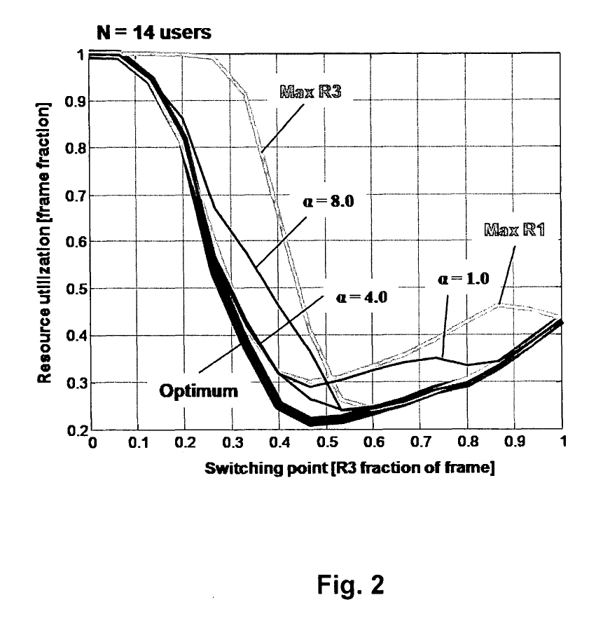

FIG. 2 is illustrating the resource utilization of a radio system depending on the switching point.

FIG. 1 is illustrating the basic principle of FFR, wherein each mobile station or flow is either served in the Reuse 3 or Reuse 1 Zone of the downlink (DL) radio frame, depending on the signal quality. There is illustrated a DL MAC frame, wherein MAC means Media Access Control. There is illustrated a cell with three sectors with regard to the base station.

A preferred embodiment constitutes a method to decide which mobile stations or flows are served in which FFR zone in each Mobile WiMAX downlink radio frame. The proposed zone assignment scheme comprises two important ideas:
1. The relative resource quality in both FFR zones has to be considered as the metric for the zone assignment decision. The higher the resource quality for a given service flow compared to all other active flows in a certain zone, the higher should be the according preference for that zone.
2. The relative zone size is considered in the assignment decision. The larger the relative FFR zone size, the higher should be the according value of the preference metric for service flows with high relative resource quality in that zone.

To incorporate the ideas in a zone assignment method, the following two metrics are defined:

$${φ}_{1 i} = \frac{{γ}_{1 i} \cdot N}{{\sum }_{k = 1}^{N} {γ}_{1 k}} \times \frac{{S}_{1}}{{S}_{1} + {S}_{3}}$$

$$and$$

$${φ}_{3 i} = \frac{{γ}_{3 i} \cdot N}{{\sum }_{k = 1}^{N} {γ}_{3 k}} \times \frac{{S}_{3}}{{S}_{1} + {S}_{3}} \times α .$$

In these formulas, y₁ᵢ and y₃ᵢ are the downlink SINRs of a flow i of the Reuse 1 Zone and Reuse 3 Zone, respectively. N is the number of flows to be served in the frame, and S1 and S3 are the overall number of usable resources—time-frequency slots in Mobile WiMAX—in Reuse 1 and Reuse 3 Zone. Hence the first factor in the metrics represents the relative resource quality in each zone, and the second factor represents the relative zone size.

The factor α is used for tuning and can be chosen freely by the operator. Note that all the input variables are available at the BS, either gathered by using MS feedback mechanisms such as downlink SINR reports, or as system parameter like the reuse zone size in terms of number of usable time-frequency resources.

The preferred zone assignment method consists of the following three steps:

### 1. Step

Determination of new zone preference metric for service flows:

for each flow i

calculate φ_{1,i} and φ_{3,i}
if (φ_{1,i} > φ_{3,i})

preferred_zoneᵢ = Reuse 1 Zone
φᵢ = φ_{1,i}

else

preferred_zoneᵢ = Reuse 3 Zone
φᵢ = φ_{3,i}

end

end

### 2. Step

Creation of a sorted list of all flows that have to be served in the current downlink radio frame, with preference or sorting criterion φᵢ in descending order.

### 3. Step

Assignment of flows to zones, starting with the first flow in the sorted list according to the preferred zone. If no resources are available any more in the preferred zone, the flow is assigned to the other zone. The amount of required resources for a flow in a given zone is determined by the modulation and coding scheme (MCS) based on the SINR level and the throughput requirement

FIG. 2 is showing the resource utilization depending on the switching point and especially the results of a performance evaluation of the novel method for a 19 cell deployment scenario with three sectors per cell and 14 active VoIP flows in each sector. The performance of the proposed method is compared with performance of two methods already proposed in the state of the art and denoted as Max R1 and Max R3, and the optimum zone assignment—brute force search—in terms of resource utilization. With Max R1, the Reuse 1 Zone is first filled up with service flows having the highest SINR levels in that zone; and with Max R3, the Reuse 3 Zone is filled up first. Within the above brute force search all possible parameter combinations are used to find the optimum zone assignment in terms of resource utilization.

The x-axis of the FIG. 2 shows the switching point in the downlink radio frame between Reuse 1 and Reuse 3 Zone, and the y-axis the resulting resource utilization, where 1.0 denotes a completely filled frame. The black curve shows performance of the new method with optimal setting of tuning factor α in terms of minimizing the resource utilization.

The best value of α in this case is α=4.0 according to FIG. 2.

The performance evaluation reveals the following:
1. The novel method is bounded by the Max R1 and Max R3 results. For a low value of α, the results approach the results of the Max R1 method, while high values of α lead to Max R3 behaviour.
2. The method can be adapted to the switching point of the frame, outperforming the Max R1 and Max R3 methods.
3. With a proper setting of α, the new method is more robust against variations in the switching point position than Max R1 and Max R3.
4. The proposed method shows close to optimum performance without adding significant complexity to Max R1 and Max R3.

Important features of the invention are:
1. Dynamic assignment of service flows to FFR zones under consideration of relative resource quality in terms of SINR level.
2. Consideration of relative zone size in zone preference metric.
3. Additional tuning factor for adaptation to service flow numbers.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for operating a cellular radio system within which at least two different Fractional Frequency Reuse (FFR) zones are defined in a downlink frame, comprising the following steps:
Providing of a metric for assigning a respective preference criterion to each of at least some flows to be served within the radio system, wherein the metric is related to the relative resource quality in the zones for the at least some flows and to the relative zone size;
assigning of the respective preference criterion to each of the at least some flows; and
assigning of the at least some flows to the zones according to the respective preference criterion.

2. A method according to claim 1, wherein the method is further comprising the step of creating of a sorted list of the at least some flows according to the respective preference criterion after the step of assigning of the preference criterion to each of the at least some flows, so that the assigning of the at least some flows to the zones will be performed according to the list.

3. A method according to claim 2, wherein the list is created in descending order with regard to the preference criterion.

4. A method according to claim 2, wherein the assigning of the at least some flows to the zones is starting with the first flow in the sorted list according to the preferred zone.

5. A method according to claim 1, wherein the relative resource quality is related to the SINR (Signal-to-Interference-and-Noise-Ratio) with regard to the respective flow.

6. A method according to claim 1, wherein the relative zone size is related to the number of usable resources within the zones.

7. A method according to claim 6, wherein the usable resources are time-frequency slots in the radio system.

8. A method according to claim 1, wherein the Fractional Frequency Reuse (FFR) zones are time zones.

9. A method according to claim 1, wherein the assignment of the at least some flows to the zones according to the respective preference criterion will be performed by a base station (BS).

10. A method according to claim 1, wherein all input variables for the metric are available at a base station (BS).

11. A method according to claim 10, wherein the variables are gathered by using a mobile station (MS) feedback mechanism, preferably downlink SINR reports.

12. A method according to claim 10, wherein the variables are available as a system parameter.

13. A method according to claim 1, wherein the amount of required resources for a flow in a given zone is determined by the modulation and coding scheme (MCS) based on the SINR level and the throughput requirement.

14. A method according to claim 1, wherein the radio system is a Mobile WiMAX system.

15. A cellular radio system, preferably for carrying out the method according to claim 1, within which at least two different Fractional Frequency Reuse (FFR) zones are defined in a downlink frame, comprising:
Means for processing of a metric for assigning a respective preference criterion to each of at least some flows to be served within the radio system, wherein the metric is related to the relative resource quality in the zones for the at least some flows and to the relative zone size;
means for assigning of the respective preference criterion to each of the at least some flows; and
means for assigning of the at least some flows to the zones according to the respective preference criterion.

16. A cellular radio system according to claim 15, wherein all means are part of or are integrated within a base station (BS) of the system.

17. A method according to claim 3, wherein the assigning of the at least some flows to the zones is starting with the first flow in the sorted list according to the preferred zone.
